(19) United States
(12) Patent Application Publication
(10) Pub. No.: US 2008/0182453 A1
(43) Pub. Date: Jul. 31, 2008

(54) ELECTRICAL CONNECTOR

(75) Inventor: TED JU, KEELUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: LOTES CO., LTD., KEELUNG CITY (TW)

(21) Appl. No.: 11/832,231

(22) Filed: Aug. 1, 2007

(30) Foreign Application Priority Data
Jan. 26, 2007 (CN) 200720047852.1

(51) Int. Cl. H01R 13/648

(52) U.S. Cl. 439/608

(57) ABSTRACT

An electrical connector includes an insulating body, a plurality of terminals, a plurality of shielding layers, and a plurality of insulating layers. The insulating body has a plurality of terminal-receiving holes. The shielding layers are mounted on the terminal-receiving holes. The insulating layers are mounted on the shielding layers, and the terminals are disposed in the terminal-receiving holes. Thereby, the insulating layers prevent EMI between terminals and ensure the terminals do not contact the shielding layers.

### BACKGROUND OF THE INVENTION

1. Field of the Invention

The present invention relates to an electrical connector, and in particular to an electrical connector having a shielding layer for preventing EMI (Electromagnetic Interference).

2. Description of the Prior Art

As computer and digital technology have advanced, the need for products to transmit data faster has been constant. To obtain the high data transmission speed, there are a number of electrical connectors with high terminal density available on the market such as LGA (Land Grid Array) connector. However, how to protect the transmission of data from EMI is an issue in the development of high terminal density technology. The ordinary method for preventing EMI is to install a layer of a metal or set a plated film on the surface of the insulating body to improve the quality of EMI protection. However, because the metal layer is only disposed on the surface of the insulating body, the influence of EMI between terminals to the properties of electrical connector are also huge when the electrical connectors have the high terminal density, thereby it reduces the ability of the electrical connector to transmit signals. In view of this, the inventor proposes the present invention to overcome the above problems.

### SUMMARY OF THE INVENTION

An object of the present invention is to provide an electrical connector that reduces EMI efficiently between terminals and prevents the terminals from contacting the shielding layers that are disposed in the plurality of terminal-receiving holes.

In order to achieve the above object, the present invention provides an electrical connector which comprises an insulating body, a plurality of terminals, a plurality of shielding layers, and a plurality of insulating layers. The insulating body has a plurality of terminal-receiving holes. The shielding layers are mounted on the terminal-receiving holes. The insulating layers are mounted on the shielding layers, and the terminals are disposed in the terminal-receiving holes.

The advantages of the present invention lie in that the shielding layers are mounted on the insulating body and the insulating layers are mounted on the shielding layers, thereby reducing EMI between terminals and preventing the terminals from contacting the shielding layers in the terminal-receiving holes. By preventing EMI and static electricity the present invention also prevents the terminals from grounding and contacting each other. As a result, the stability of the electrical connector is improved, the structure is simple, and the cost is reduced.

### BRIEF DESCRIPTION OF THE DRAWINGS

FIG. 1 is a cross-sectional view showing a portion of the electrical connector of the present invention;

FIG. 2 is an enlarged perspective view showing a portion of the electrical connector of the present invention;

FIG. 3 is an enlarged perspective view of the top view showing a portion of the electrical connector of the present invention.

### DETAILED DESCRIPTION OF THE INVENTION

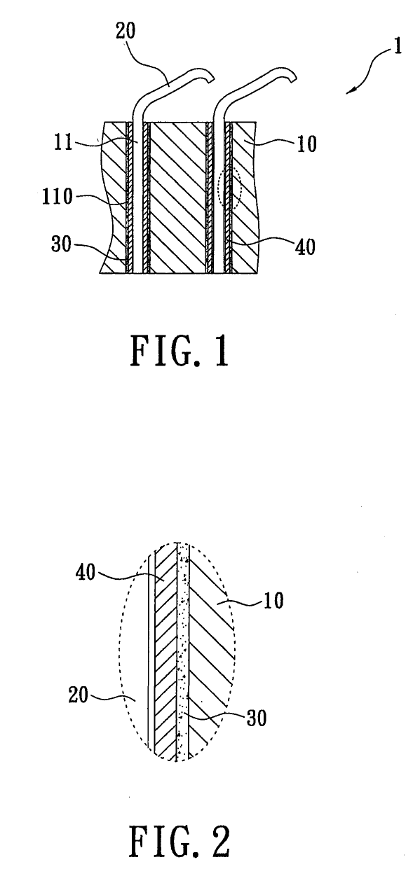

Please refer to FIG. 1 and FIG. 2, in which the present invention of an electrical connector 1 is shown. The electrical connector 1 includes an insulating body 10 and a plurality of terminals 20. The insulating body 10 has a plurality of terminal-receiving holes 11 and the terminals 20 are set in the terminal-receiving holes 11. A plurality of shielding layers 30 are attached to an inner wall 110 of each of the terminal-receiving holes 11. The shielding layers 30 can prevent crosstalk that occurs due to the near gap of the terminals 20. A plurality of insulating layers 40 that are covered with and attached to the shielding layers 30 prevent the terminals 20 from contacting the shielding layers 30.

The shielding layers 30 that are disposed around the terminal-receiving holes 11 and correspond to the shape of the terminal-receiving holes 11 can be metal housings. The shielding layers 30 also can be metal films plated to the inner wall 110 of the terminal-receiving holes 11 by using a vacuum, a sputtering or a coating method. The shielding layers 30 that are attached to the inner wall 110 of the terminal-receiving holes 11 can further be foil made of good ductility metal.

The shielding layers 30 are covered with the insulating layers 40. The insulating layers 40 can be plastic housings or formed on the shielding layers 30 by molding. The insulating layers 40 also can be insulating coatings applied to the shielding layers 30. Furthermore, the insulating layers 40 can be plastic films that are attached to the shielding layers 30, thereby preventing the terminals 20 from contacting the shielding layers 30.

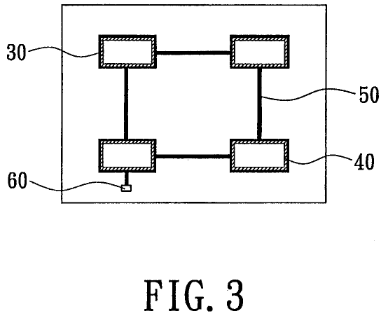

Please refer to FIG. 3, the electrical connector 1 connects to a circuit board (not shown in the Fig.). Furthermore, the electrical connector includes a conductive portion 50 that is electrically connected to the shielding layers 30 in the terminal-receiving holes. The conductive portion 50 is connected to a grounding circuit of the circuit board via a conductive sheet 60; therefore the shielding layers 30 are electrical connected with the grounding circuit of the circuit board.

The present invention prevents the terminals 20 from contacting the shielding layers 30 and prevents signal failure via the insulating layers 40 that are mounted on the shielding layers 30. The stability of the electrical connector 1 is improved.

What is claimed is:

1. An electrical connector, comprising:
an insulating body having a plurality of terminal-receiving holes;
a plurality of shielding layers mounted on the terminal-receiving holes;
a plurality of insulating layers mounted on the shielding layers; and
a plurality of terminals disposed in the terminal-receiving holes.

2. The electrical connector as claimed in claim 1, wherein the shielding layers are metal housings disposed around the terminal-receiving holes.

3. The electrical connector as claimed in claim 1, wherein the shielding layers are metal films plated to the terminal-receiving holes.

4. The electrical connector as claimed in claim 1, wherein the shielding layers are foil attached to the terminal-receiving holes.

5. The electrical connector as claimed in claim 1, wherein the insulating layers are plastic layers that cover the shielding layers.

6. The electrical connector as claimed in claim 1, wherein the insulating layers are insulating coatings applied to the shielding layers.

7. The electrical connector as claimed in claim 1, wherein the insulating layers are plastic films that are attached to the shielding layers.

8. The electrical connector as claimed in claim 1, wherein the insulating layer is disposed between the shielding layer and the terminal.

9. The electrical connector as claimed in claim 1, wherein the electrical connector further has a conductive portion that is electrically connected to the shielding layers in the terminal-receiving holes.

10. The electrical connector as claimed in claim 1, wherein the electrical connector is connected to a circuit board, and the conductive portion is connected to a grounding circuit of the circuit board.
